(19) United States
(12) Patent Application Publication
(10) Pub. No.: US 2015/0186812 A1
(43) Pub. Date: Jul. 2, 2015

(54) AGREEMENT MEDIATION METHOD AND APPARATUS

(71) Applicants: Corey MANDELL, Mill Creek, WA (US); Joel GETZENDANNER, Olympia, WA (US)

(72) Inventors: Corey MANDELL, Mill Creek, WA (US); Joel GETZENDANNER, Olympia, WA (US)

(21) Appl. No.: 14/588,350

(22) Filed: Dec. 31, 2014

Related U.S. Application Data
(60) Provisional application No. 61/922,222, filed on Dec. 31, 2013.

(51) Int. Cl. G06Q 10/06; G06Q 50/18

(52) U.S. Cl. CPC G06Q 10/0633; G06Q 50/18

(57) ABSTRACT

A computer system and set of routines through which two or more independent parties can exchange digital information or coordinate a collaborative process in a manner ultimately controlled by mutual agreement.

### CROSS-REFERENCE TO RELATED APPLICATIONS

This application claims the benefit of U.S. Provisional Patent Application Ser. No. 61/922,222, filed Dec. 31, 2013, which application is incorporated herein, for all purposes.

### FIELD

The present disclosure relates to the field of document creation, management, and data reuse.

### BACKGROUND

The volume of personal, private and proprietary information being generated, captured and shared across the Internet is exploding at exponential rates. Social media platforms, email and blogs, online commerce and web browsing have become commonly used technologies for disseminating this information. A stream of new monitoring and communications devices are hitting the market daily, broadening and deepening what information is available and how it is made available. Big data approaches are used to analyze this mountain of data, generating even further information and insights. The value of holding and utilizing this data is extraordinary, for both individuals and companies.

Significant risks come with these advances, as well. Individuals have lost privacy and control over their personal information, face targeted advertising by parties who seem to know far too much about them, and have reason to fear theft of property and identity. Companies have direct liability and reputation risk if such thefts occur on their systems, and can lose the loyalty of customers if their data gathering approach is too invasive or self-serving. High profile cases of government and corporate surveillance and theft of customer data serve to heighten public awareness and concern. Companies also face regulators that are increasingly ready to impose rules regarding whether or how companies can collect, control, establish consent, utilize and secure personal information.

Current approaches tend to approach these questions (collection, control, consent, utilization and security of information) in a piecemeal fashion, such as enabling digital signatures or multifactor authentication, or take one-size fits-all approaches, such as privacy policies, that allow for very little customer choice. Individual companies have developed turn-key systems that integrate these elements—e.g., banks—but usually by eliminating the possibility of customers easily sharing that information with others, with similar capabilities.

Disclosed is a method and system through which two or more independent parties can exchange digital information or coordinate a collaborative process in a manner ultimately controlled by mutual agreement.

### BRIEF DESCRIPTION OF THE DRAWINGS

FIG. 1 illustrates a network and device diagram in which a KM Server, one or more Services Experts, Consumers, FIRE Information Sources, and Social Media Servers are connected to a network.

FIG. 2 is a functional block diagram of an exemplary KM Server computing device and some data structures and/or components thereof.

FIG. 3 is a functional block diagram of a KM Datastore.

FIG. 4 illustrates a Workflow Routine.

FIG. 5 illustrates a Kform Creation Routine.

FIG. 6 illustrates an Agreement Control and Workflow Defining Routine.

FIG. 7 illustrates a Data Vault Routine.

### DETAILED DESCRIPTION

It is intended that the terminology used in the description presented below be interpreted in its broadest reasonable manner, even though it is being used in conjunction with a detailed description of certain examples of the technology. Although certain terms may be emphasized below, any terminology intended to be interpreted in any restricted manner will be overtly and specifically defined as such in this Detailed Description section.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the term “connected,” “coupled,” or any variant thereof means any connection or coupling, either direct or indirect between two or more elements; the coupling of connection between the elements can be physical, logical, or a combination thereof. Additionally, the words, “herein,” “above,” “below,” and words of similar import, when used in this application, shall refer to this application as a whole and not to particular portions of this application. When the context permits, words using the singular may also include the plural while words using the plural may also include the singular. The word “or,” in reference to a list of two or more items, covers all of the following interpretations of the word: any of the items in the list, all of the items in the list, and any combination of one or more of the items in the list. References are made herein to routines and subroutines; generally, it should be understood that a routine is a software program executed by computer hardware and that a subroutine is a software program executed within another routine. However, routines discussed herein may be executed within another routine and subroutines may be executed independently (routines may be subroutines and visa versa).

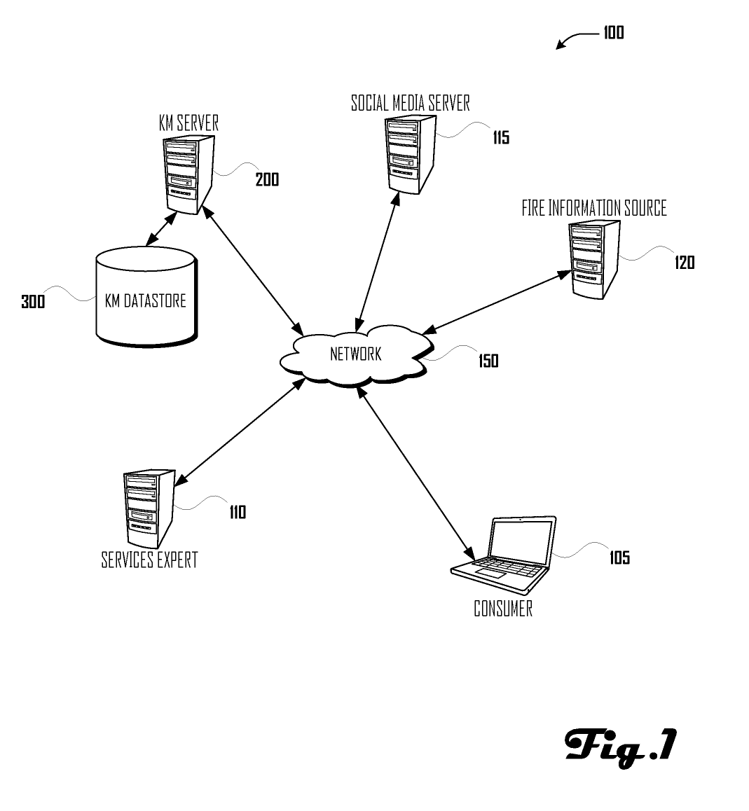

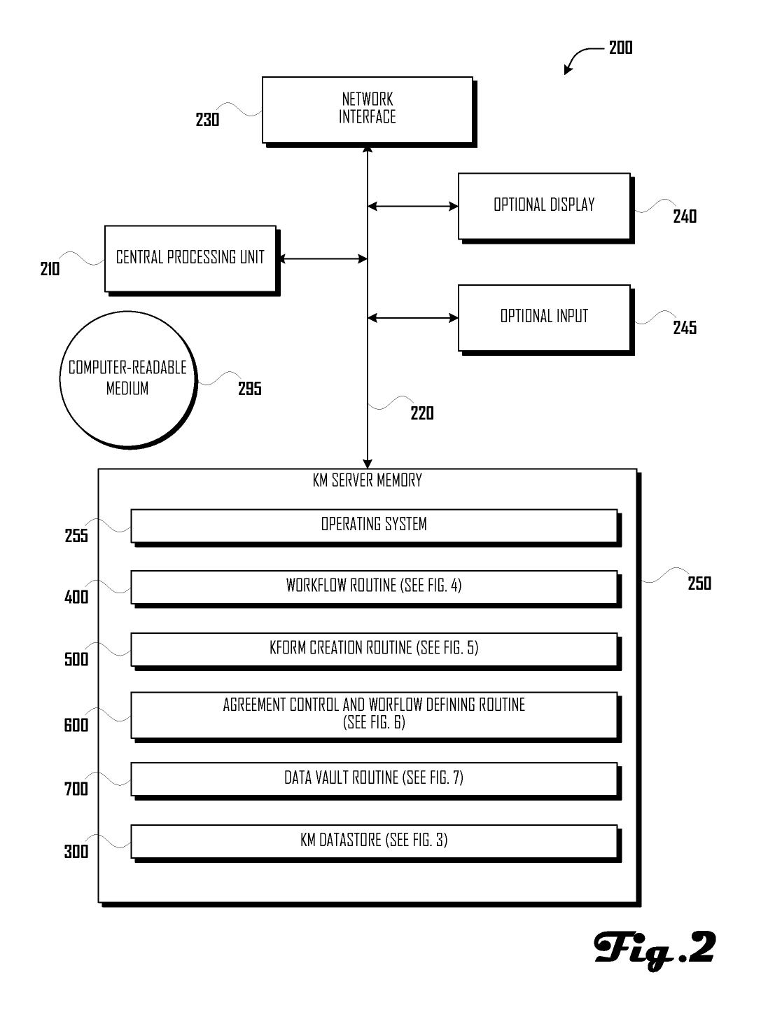

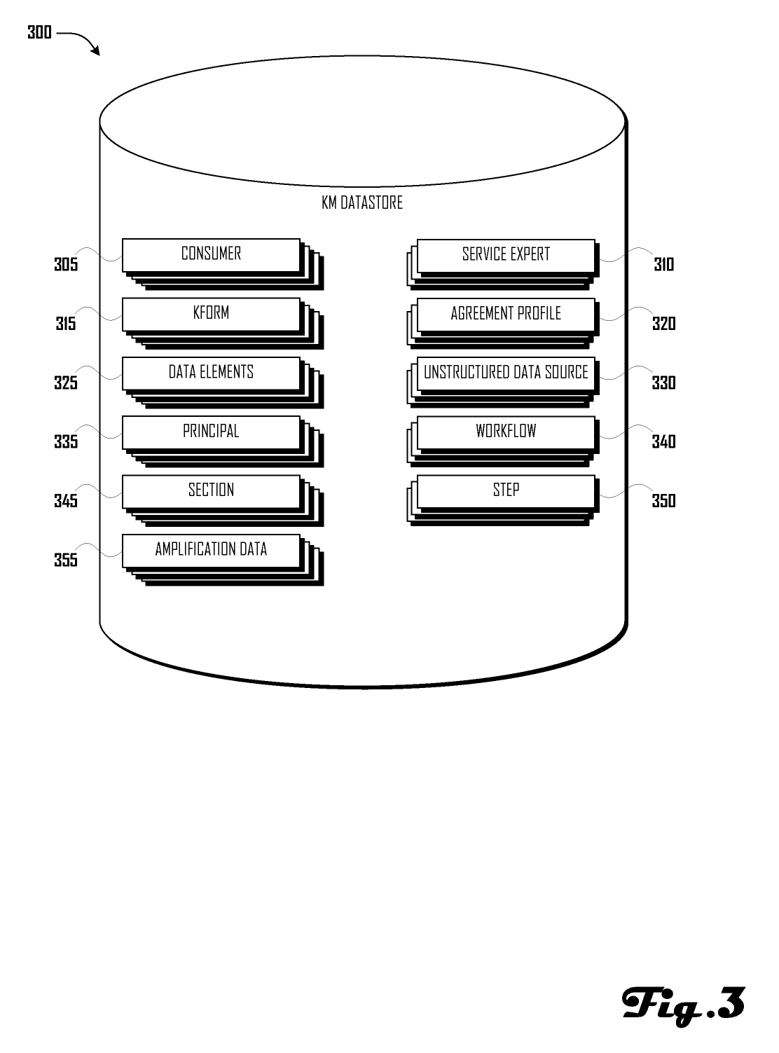

FIG. 1 illustrates a network and device diagram in which a KM Server 200, KM Datastore 300, and one or more Consumers 105, Services Experts 110, FIRE Information Sources 120, and Social Media Servers 115 are connected to a network. KM Server 200 is discussed further in relation to FIG. 2. KM Datastore 300 is discussed further in relation to FIG. 3. Consumer 105 is an individual, including private individuals and individuals in organizations, utilizing a computing device such as, for example, a mobile phone, smart phone, tablet computer, laptop or desktop computer, or the like. Services Expert 110 is a party who provides services, such as tax or accounting services, valuation services, sales services, record keeping services, and the like and who utilizes a computing device such as, for example, a mobile phone, smart phone, tablet computer, laptop or desktop computer, server computer or the like. FIRE Information Source 120 is a party who provides financial services, insurance services, real estate services, and the like (abbreviated as “FIRE”) and who utilizes a computing device such as, for example, a mobile phone, smart phone, tablet computer, laptop or desktop computer, server computer or the like. Social Media Server 115 is a provider of social media services, such as Facebook, Twitter, and the like, provided via a computing device such as a server computer.

The computing devices are illustrated in FIG. 1 as connecting to Network 150. Connection to Network 150 or direct connection between computing devices may require that the computers execute software routines which enable, for example, the seven layers of the Open System Interconnection (OSI) model of computer networking or equivalent in a wireless phone or wireless data network. Network 150 comprises computers, network connections among the computers, and software routines to enable communication between the computers over the network connections. Network 150 may comprise, for example, an Ethernet network and/or the Internet. Communication among the various computers and routines may utilize various data transmission standards and protocols such as, for example, the application protocol HTTP. Transmitted data may encode documents, files, and data in various formats such as, for example, HTML, XML, flat files, and JSON.

This paper may discuss components as connecting to KM Server 200 or to KM Datastore 300; it should be understood that such connections may be to, through, or via the other of the two components (for example, a statement that a computing device connects with or sends data to KM Server 200 should be understood as saying that the computing device may connect with or send data to KM Datastore 300). References herein to “database” should be understood as equivalent to “Datastore.” Consumer 105, Services Expert 110, FIRE Information Source 120, and Social Media Server 115 may comprise a datastore. Although illustrated in these Figures as components integrated in one physical unit, the computers, servers and databases may be provided by common (or separate) physical hardware and common (or separate) logic processors and memory components.

KM Server 200 illustrated in FIG. 1 is further illustrated in FIGS. 2 and 3 as comprising data groups for routines (illustrated in FIG. 2, within KM Server Memory 250) and data groups used by routines (illustrated in FIG. 3). In addition to the data groups explicitly illustrated, additional data groups may also be present on and/or executed by this device, such as routines for databases, webservers, and web browsers, and routines to enable communication with other computers. The data groups used by routines may be represented by a cell in a column or a value separated from other values in a defined structure in a digital document or file. Though referred to herein as individual records or entries, the records may comprise more than one database entry. The database entries may be, represent, or encode numbers, numerical operators, binary values, logical values, text, string operators, joins, conditional logic, tests, ‘name:value’ pairs, and similar.

The browser routines may provide an interface for interacting with other computers through, for example, a webserver routine (which may serve data and information in the form of webpages). The web browsers and webservers are meant to illustrate or refer to user-interface and user-interface enabling routines generally, and may be replaced by equivalent routines for serving and rendering information to and in a user or device interface. Log-in credentials and local instances of user or device profiles may be stored in or be accessible to KM Server 200, Consumer 105, Services Expert 110, FIRE Information Source 120, and Social Media Server 115. Such user or device profiles and/or credentials associated therewith or therein (“credentials”) may be utilized to provide secure communication between the computers. User or device profiles of Social Media Server 115 may be utilized by, for example, KM Server 200, or visa versa.

As an example of utilization of credentials, access to Kform 315 components, such as Data Elements 325, Agreement Profiles 320, Workflow 340, Amplification Data 355 and the like, as well as use of routines such as Workflow Routine 400, Kform Creation Routine 500, Agreement Control and Workflow Defining Routine 600, and Data Vault Routine 700 may require authentication and authorization with credentials. For example, a Kform 315 may be posted on Facebook or another Social Media Server 115; if the Agreement Profile 320 for one or more Sections 345 of the Kform 315 allow it (application of Agreement Profile 320 settings to Sections 345 in Kform 315 is discussed further below), the Kform 315 may be viewable via the Social Media Server 115, via a website, via a PDF, via email, or the like; optionally, information inserted in Kform 315 may require credentials of a Principal 335 and, once entered, may preclude display via Social Media Server 115 or other public or semi-public forum, or may require presentation of credentials to authorize such display.

The software routines and data groups used by the software routines may be stored and/or executed remotely relative to any of the computers through, for example, application virtualization.

FIG. 2 is a functional block diagram of an exemplary KM Server 200 computing device and some data structures and/or components thereof. The computing device 200 comprises at least one Processing Unit 210, KM Server Memory 250, and an optional Display 240 and Input 245 all interconnected along with Network Interface 230 via a Bus 220. Network Interface 230 may be utilized to form connections with Network 150 and to send and receive radio frequency (“RF”) and other wireless and wireline signals.

KM Server Memory 250 generally comprises a random access memory (“RAM”), a read only memory (“ROM”), and a permanent mass storage device, such as a disk drive or SDRAM (synchronous dynamic random-access memory). KM Server Memory 250 stores program code for software routines, such as, for example, Workflow Routine 400, Kform Creation Routine 500, Agreement Control and Workflow Defining Routine 600, Data Vault Routine 700, as well as browser, webserver, email client and server routines, camera, image and audio processing routines, other client applications, and database applications. Webserver and browser routines may provide an interface for interacting with the other computing devices illustrated in FIG. 1, such as with Consumer 105, Services Expert 110, FIRE Information Source 120, and Social Media Server 115 (all which may serve and respond to data and information in the form of webpages and html documents or files). The browsers and webservers are meant to illustrate user-interface and user-interface enabling routines generally, and may be replaced by equivalent routines for serving and rendering information to and in a user interface in a computing device (whether in a web browser or in, for example, a mobile device application).

In addition, KM Server Memory 250 also stores Operating System 255. These software components may be loaded from non-transient Computer Readable Storage Medium 295 into KM Server Memory 250 of the computing device using a drive mechanism (not shown) associated with non-transient Computer Readable Storage Medium 295, such as a floppy disc, tape, DVD/CD-ROM drive, memory card, or other like storage medium. In some embodiments, software components may also or instead be loaded via a mechanism other than a drive mechanism and Computer Readable Storage Medium 295 (e.g., via Network Interface 230).

The computing device 200 may also comprise hardware supported input modalities, Input 245, such as, for example, a touchscreen, a keyboard, a mouse, a trackball, a stylus, a microphone, accelerometer(s), compass(es), RF receivers (to the extent not part of Network Interface 230), and a camera, all in conjunction with corresponding routines.

KM Server 200 may also comprise or communicate via Bus 220 with KM Server Datastore 300, illustrated in KM Server Memory 250 and further illustrated in FIG. 3. In various embodiments, Bus 220 may comprise a storage area network (“SAN”), a high speed serial bus, and/or other suitable communication technology. In some embodiments, KM Server 200 may communicate with KM Server Datastore 300 via Network Interface 230. KM Server 200 may, in some embodiments, include many more components than those shown in this Figure. However, it is not necessary that all of these (or other) generally conventional components be shown in order to disclose an illustrative embodiment.

FIG. 3 is a functional block diagram of KM Datastore 300 illustrated in FIG. 2. The components of KM Datastore 300 are data groups used by routines and are discussed further herein in the discussion of other of the Figures. Consumer 305 may be a record assigned to Consumer 105 by KM Server 200 in a process used to create authorized Consumer 105 users. Service Expert 310 may be a record to Service Expert 110 by KM Server 200 in a process used to create authorized Service Expert 110 users. Principals 335 may be Consumer 305 or Service Expert 310. Data Element 325 records may comprise a name:value pair (or the like), with the name of the Data Element 325 and the value of the Data Element 325 and may further comprise a “descriptor”, such as a category and/or sub-category assigned to the Data Element 325.

In addition to the data groups used by routines illustrated in FIG. 3, credentials may be stored in, be accessible to all, and/or may be provided by users of the computing devices illustrated in FIG. 1.

In overview, and referring to FIGS. 1-3, KM Server 200 may provide a set of Data Elements 325 and/or a set of Kforms 315 comprising Section 345, which Sections 345 comprise Data Elements 325. The Data Elements 325 and/or Kforms 315 may be used by Workflow Routine 400, Kform Creation Routine 500, Agreement Control and Workflow Defining Routine 600. In addition to Kforms 315 and/or Data Elements 325 provided by KM Server 200, Consumer 105 and Service Experts 110 may create and/or customize Data Elements 325 and/or may compose Data Elements 325 in Sections 345 in new Kforms 315. FIRE Information Sources 120 may also be Service Experts 110 (creating Kforms 315) and/or may be delegated to be Principals 335 according to Agreement Profile 320 settings. Principals 335 may provide values for Data Elements 325 in Workflows 340 and may create Workflows 340. Agreement Profile 320 settings may be utilized to define Principals 335 and to form Workflows 340, which Workflows 340 may be utilized by Workflow Routine 400 to present to and/or obtain information from Principals 335 and others permitted by and designated in Agreement Profile 320 settings, which communications may take place using all available communication technologies including, for example, emailed documents, PDFs, Social Media Server 115, websites, smartphone apps, audio, visual, or text “chat” sessions, and the like. Workflows 340 may comprise Steps 350, each of which at least relates to presentation of or a request for a value of a Data Element 325. Agreement Profile 320 settings relative to Data Elements 325, Sections 345, and Kforms 315 may be modified over time by Principals 335, Consumers 305, Service Experts 310, and other delegates of this control. An unmodified or modified value of a first Data Element 325 or set of Data Elements 325 may be assigned as the value of a second Data Element 325 or set of Data Elements 325.

For example, a Data Element 325 in a Kform 315 may contain a value for a party's name, which Data Element 325 may be authorized by Agreement Profile 320 settings for public display by Social Media Server 115, but which only Consumer 305 is authorized to modify and, potentially, only with governmental authority (a governmental entity may be assigned as a Principal 335 for modifying the value of the Kform 315 for the party's name).

Other Data Elements 325 associated with the Consumer 305 in other Kforms 315 and/or other Sections 345 of other Kforms 315 may contain values comprising information such as a monetary amount owed to or owed by the Consumer 305 in an account in a financial institution, which Data Elements 325 may be associated with a Principal 335, such as an officer at such financial institution, and which Data Elements 325 may be authorized by Agreement Profile 320 settings for reproduction in limited Kforms 315, such as in Kforms 315 presenting financial information to Consumer 305 and/or to a delegated Principal 335 or other party and/or in tax forms, loan applications (which may be Kforms 315), and the like. For example, when Consumer 305 applies for a loan utilizing a new Kform 315, the new Kform 315 may require information from other pre-existing Kforms 315 (and Data Elements 325 therein) associated with Consumer 305. The Agreement Profile 320 settings for Sections 345 in such other pre-existing Kforms 315 may require that that Principals 335 designated relative to Sections 345 in such other pre-existing Kforms 315 approve such release or re-use of the information by changing Agreement Profile 320 settings for the Sections 345 in such pre-existing Kforms 315. The request for and implementation of such changes may be accomplished by Workflow Routine 400. Similar Kforms 315 may be utilized to contain the appraised or actual sale price of a real estate property (with designation of an appropriate Principal 335), to note the occurrence of payments, and the like.

All information entered into KM Datastore 300 may be retained and time-stamped, allowing roll-back of changes and the designation of use of time-determined values of Data Elements 325.

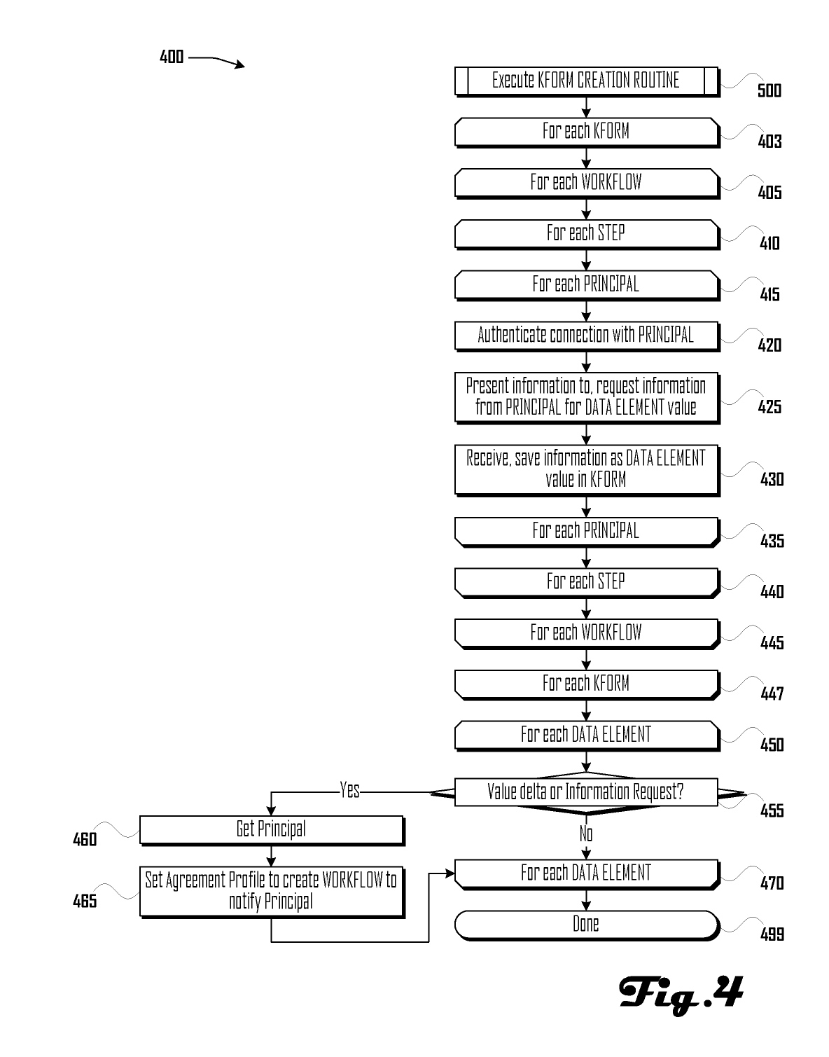

FIG. 4 illustrates an example of a Workflow Routine 400, which Workflow Routine 400 may be used to implement a Workflow 340 defined by Agreement Profile 320 settings set in the Agreement Control and Workflow Defining Routine 600.

At block 500 in FIG. 4, if not already performed, Kform Creation Routine 500 may be executed to create Kform 315. As discussed elsewhere, Kform 315 comprises Data Elements 325 arranged in Section 345. Section 345 may comprise Agreement Profile 320 settings, which settings may control access to and modification of Data Elements 325 in Section 345 and create Workflow 340.

Blocks 403 to 447 may iterate for each Kform 315. Blocks 405 to 445 may iterate for each Workflow 340 within or associated with the then-current Kform 315. Blocks 410 to 440 may iterate for each Step 350 in the then-current Workflow 340. Blocks 415 to 435 may iterate for each Principal 335 in the then-current Step 350.

At block 420, Workflow Routine 400 may authenticate a connection with Principal 335. At block 425, Workflow Routine 400 may present information to and/or request information from Principal 335 relating to Data Element 325 which is subject to the then-current Step 350, according to Agreement Profile 320 settings.

If information was requested at block 425, then at block 430, the information may be received and saved as a value in the pertinent Data Element 325 record.

At block 435, Workflow Routine 400 may return to block 415 to iterate over the next Principal 335 in the then-current Step 350.

At block 440, Workflow Routine 400 may return to block 410 to iterate over the next Step 350 in the then-current Workflow 340.

At block 445, Workflow Routine 400 may return to block 405 to iterate over the next Workflow 340 in the then-current Kform 315.

Blocks 450 to 470 may iterate over each Data Element 325 in KM Datastore 300 and relate to information requests or changes in or requests to change Data Elements 325, which may occur outside of a Workflow 340. Block 450 to 470 may be executed independently of blocks 403 to 447. At block 455, Workflow Routine 400 may determine whether a value of Data Element 325 has changed or whether a request has been received for or a request has been received to change Data Element 325. If affirmative, then at block 460, Workflow Routine 400 may obtain the Principal 335 associated with Data Element 325. At block 465, if authorized by the Agreement Profile 320 settings for the Data Element 325 or for Sections 345 within which Data Element 325 may occur, Workflow Routine 400 may set Agreement Profile 320 settings to create a Workflow 340 relating to the value change, request for Data Element 325, or request to change Data Element 325.

At block 470, Workflow Routine 400 may return to iterate over the next Data Element 325.

At block 499, Workflow Routine 400 may conclude, return to a waiting state, or may return to another process, such as one which may have initiated the routine.

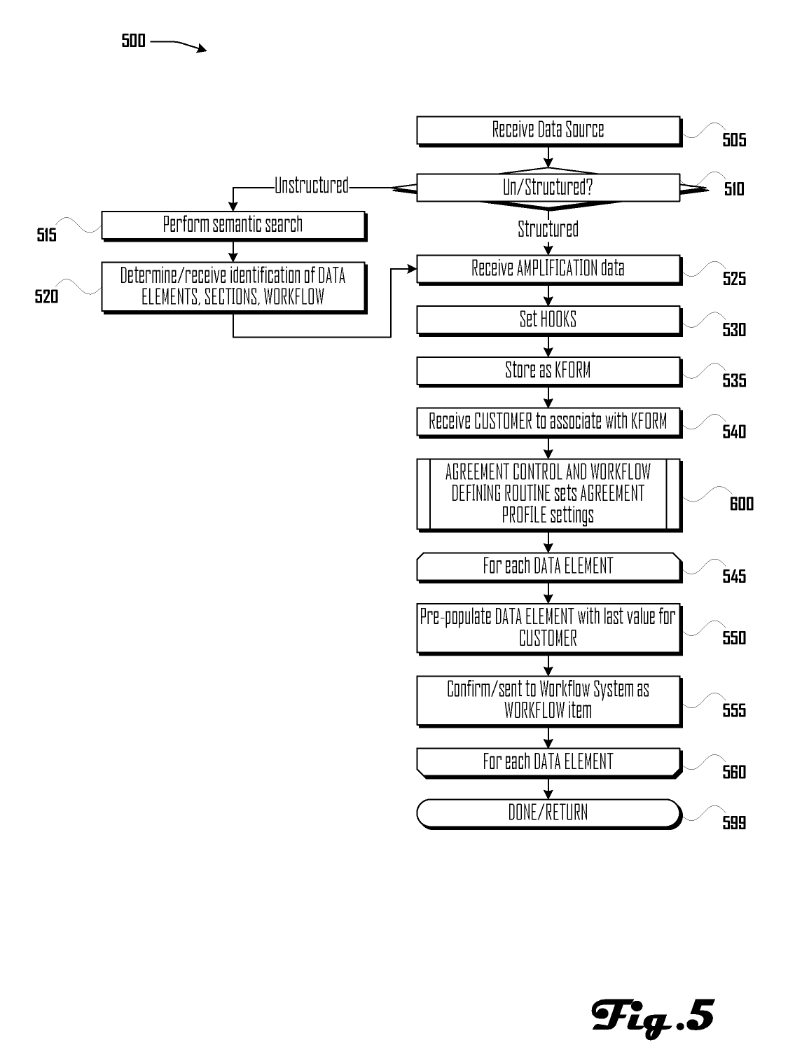

FIG. 5 illustrates a Kform Creation Routine 500. Kform Creation Routine 500 may be used by Services Expert 110, Consumer 105, or the like to create Kforms 315. At block 505, Kform Creation Routine 500 may receive a data source to be used as a Kform. Receipt of the data source may be in the form of an uploaded PDF or image, a selection of a template of a Kform in a website, a selection of a Data Element 325 from a palette of Data Elements 325, and the like.

At block 510, a determination may be made by Kform Creation Routine 500 regarding whether the data source is structured or at least partially unstructured. A structured data source may be one which comprises or is associated with Data Elements 325, Sections 345, Dataflow 340, and Agreement Profile 320 records. An unstructured (or at least partially unstructured) data source may be, for example, an image of a document, a handwritten document, an audio file, and the like.

If unstructured or partially unstructured at block 510, then at block 515, Kform Creation Routine 500 may perform a semantic search of the unstructured data source. A semantic search may comprise, for example, optical image recognition (“OIR”) and/or optical character recognition (“OCR”), word recognition (dictation) of an audio file, as well as identification of semantic components within the output of the OIR, OCR, or dictation, such as identification of addresses, numerical values, currency identifiers, and the like. Identification of semantic components may be based on a match with pre-existing patterns and/or may be accomplished through human input.

A semantic search on an unstructured data source may be performed, for example, to allow Consumer 305 to upload information which the Consumer 305 may need to or would like to refer to in future in Data Elements 325 in Kforms 315. For example, Consumer 305 may be asked to complete an insurance application, which may or may not be a Kform 315. The insurance application may include a request for a VIN number of a vehicle of Consumer 305. The data Vault for the Consumer 305 may not yet include a Data Element 325 with a VIN number. The Consumer 305 may take a photo or scan the insurance application and may upload it to the Kform Creation Routine 500 as an unstructured data source. Kform Creation Routine 500 may perform a semantic search on the insurance application image and may identify the presence of the VIN number. Identification of the VIN number may be automatic or may be guided by the Customer 305 or a Service Expert 310 working for or with Customer 305. The image of the insurance application may be saved as a Kform 315 and the Data Elements 325 in it may be available for use in other Kforms 315, with access to and use of such Data Elements 325 being set by Agreement Profile 320 settings created, for example, through use of Agreement Control and Workflow Defining Routine 600.

At block 520, Kform Creation Routine 500 may determine, such as based on a match with an existing Kform, or may receive identification of Data Elements 325, Sections 345 comprising Data Elements 325, and, if any, a Workflow 340 comprising Agreement Profile 320 settings for a Section 345. At this block, a descriptor, such as a category or sub-category may be assigned to Data Elements 325. This may be performed automatically, by Kform Creation Routine 500, and/or with human guidance.

At block 525, Kform Creation Routine 500 may receive Amplification Data 355. Amplification Data 355 may comprise, for example, a plain language description of legal text or of an image, a description, hint, summary, or the like. At block 530, Kform Creation Routine 500 may receive and set communication “hooks”, which communication hooks may allow a Consumer 305, Service Expert 310, Principal 335, or other party to communicate regarding Kform 315, a Section 345 thereof, a Data Element 325 thereof, an Amplification Data 355, or the like. The communication may be via a chat session, via an email, via a forum in a website, via a forum in a social media service, or the like. The communication session may require the authentication and authorization of the parties involved.

At block 535, Kform Creation Routine 500 may store the output of the preceding blocks as Kform 315. Kform 315 may be a template for later re-use with empty or place-holder values in Data Elements 325, with Data Element 325 values supplied during the preceding blocks, or may be intended to be a “one-off” Kform 315.

At block 540, Kform Creation Routine 500 may receive a Consumer 305 to associate with Kform 315.

At block 600, Kform Creation Routine 500 may execute Agreement Control and Workflow Defining Routine 600 to set access control for Sections 345 and to create Workflow 340, using Agreement Profile 320 settings. Workflows 340 created at block 600 may be implemented by Workflow Routine 400.

Blocks 545 to 560 may iterate for each Data Element 325 of Kform 315.

At block 550, Kform Creation Routine 500 may pre-populate Data Element 325 in Kform 315 with a most recent value for the Data Element 325 for Consumer 305 of block 540. At block 555, Kform Creation Routine 500 may confirm the pre-populated Data Element 325 with the party creating the Kform 315, with the Principal 335 of the Data Element 325 or may otherwise create a Workflow 340 record to obtain such confirmation, which Workflow 340 record may be processed by Workflow Routine 400.

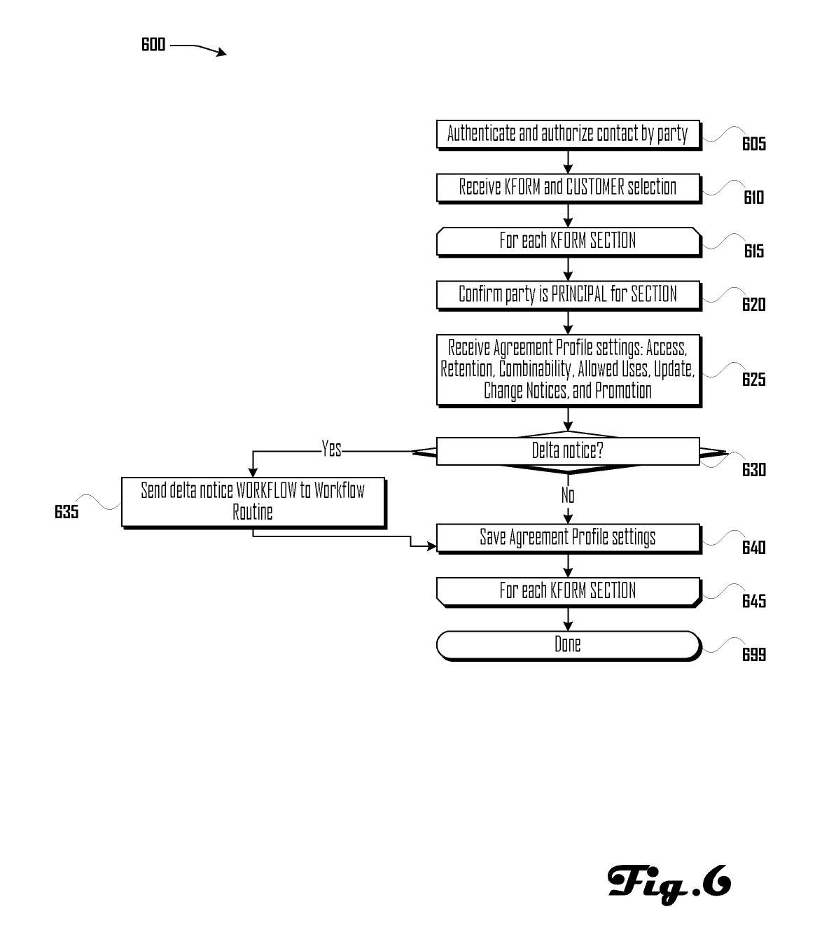

FIG. 6 illustrates an example of an Agreement Control and Workflow Creation Routine 600. Agreement Control and Workflow Creation Routine 600 may be used by a Services Expert 110, a Consumer 105, or the like to set access control for Sections 345 and to create Workflow 340, using Agreement Profile 320 settings.

At block 605, if not already performed, a contact by a party has been received and is authenticated and authorized as, for example, Consumer 205, Service Expert 310, or Principal 335.

At block 610, a selection of a Kform 315 and a Consumer 305 associated therewith is received from the contacting party of block 605.

Blocks 615 to 645 may iterate for each Section 345 in Kform 315.

At block 620, Agreement Control and Workflow Creation Routine 600 may receive Agreement Profile 320 settings for Section 345. Agreement Profile 320 settings may comprise a selection or set of selections from a matrix of access control and other settings which may determine who can view a Data Element 325 within Section 345, who can change Data Element 325 within Section 345, who will receive notice of a change in Data Element 325 within Section 345, how Data Element 325 within Section 345 can be combined with other Data Elements 325 within other Sections 345, when (such as upon a date, after passage of a period, or upon an occurrence of a condition) Data Element 325 within Section 345 may be displayed, used to supply a value for another Data Element 325 or the like, when a value of a Data Element 325 is designated as a controlling value for a category or sub-category of Data Elements 325, who is allowed to subscribe to view or see changes relating to a Data Element 325, and the like. An example of a matrix of Agreement Profile 320 settings is provided in Table 1. This table is provided as an example; rows and columns may be deprecated and other rows and columns may be added.

TABLE 1

| | Level 0 | Level 1 | Level 2 | Level 3 | Level 4 | Level 5 |
|---|---|---|---|---|---|---|
| Access | None | Eyes only | | Inside KM | Entrust | Transfer |
| Retention | None | One-time | Set duration | While | Until revoked | Indefinite |
| | | | | Process | | |
| | | | | Open | | |
| Identifiability | None | Unique | Group | Individual | Affiliates/ | Social |
| | | | | | household | |
| | | | | | members | |
| Combinability | None | Only within | Only same | Inside KM | Corporate | 3^{rd} Party |
| | | process | ID level | | | |
| Who | None | Express consent | Per step, individual | Per step, | Corporate | Any |
| | | | | role | | |
| Use | None | Express consent | Inside KM | Within KM | General | Any |
| | | | | process | | |
| Update | None | Express consent | Internal notification | Auto, within | External notification | Auto, outside |
| | | | | KM | | KM |
| Promotion | None | Updates | Upgrades | Related | Related 3^{rd} | Any |
| | | | | | Party | |

In the foregoing, records indicating a party, such as “Access”, “Identifiability”, and “Who” may comprise a level (as listed above) as well as identification of a specific Consumer 305, Service Expert 310, Principal 335, organization, or the like. A party, such as Consumer 305 or Service Expert 310, associated with a Section 345 may also be referred to as a “Principal” and may be associated with or identified in a Principal 335 record. In the foregoing, records indicating a date, time, or condition may comprise a level (as listed above) as well as identification of a time, date-time, passage of time, or occurrence of a condition which may be required prior to an action or which may be required to trigger an action.

Groups of Agreement Profile 320 settings may be created for use by selection of the group. For example, an Agreement Profile 320 setting group may comprise Access Level 3, Retention Level 4, and Combinability Level 1, which group may be applied to all Data Elements 325 and/or Sections 345 with a particular descriptor.

At block 630, a determination may be made regarding whether an Agreement Profile 320 setting which was changed or proposed to be changed in block 625 triggers a change notice to a Principal 335 (such as according to an “Update” setting), which change notice would be a Workflow 340. If affirmative at block 630, then at block 635, the Workflow 340 may be sent to the Workflow Routine 400 to be implemented (e.g. sending notice and obtaining confirmation).

At block 640, the modified or set Agreement Profile 320 settings may be saved.

At block 645, Agreement Control and Workflow Creation Routine 600 may return to block 615 to iterate over the next Kform Section 345, if any.

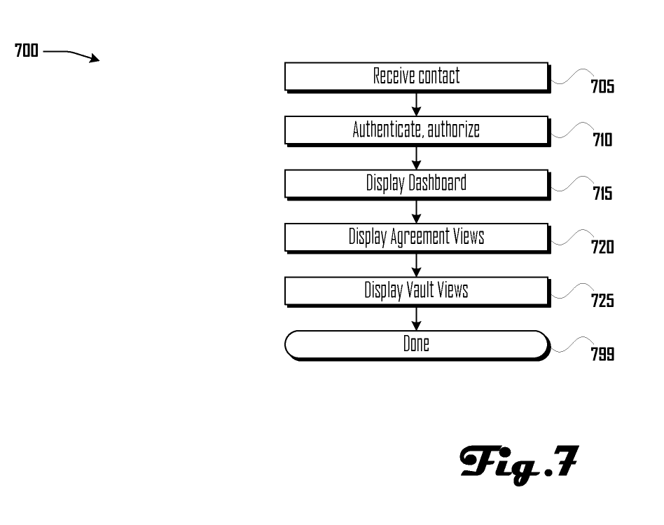

FIG. 7 illustrates an example of a Data Vault Routine 700.

At block 705, Data Vault Routine 700 may receive a contact from a party, such as a Consumer 105, Services Expert 110, or the like. At block 710, the contact may be authenticated and authorized, such as relative to authentication and authorization credentials, as Consumer 305, a Service Expert 310, or the like.

At block 715, Data Vault Routine 700 may display a dashboard comprising an overview information associated with the party, such as a list of Kforms 315 and/or Data Elements 325 associated with the party, a list of Workflows 340 associated with the party, a list of information responses provided by or requested by the party, a list of payments received or owed for services provided to or by the party, and the like.

At block 720, Data Vault Routine 700 may display a view of documents and agreements, such as Kforms 315, Unstructured Data Sources 330 and the like which may be associated with the party. If authorized by Agreement Profile 320 settings, the party may be able to view Principals 335 and Workflows 340 associated with the agreements.

At block 725, Data Vault Routine 700 may display a “Vault View”, with information, such as, for example, an amount of data used, payments owed or made, and the like.

Using the dashboard, agreement view, and data vault views, the party may be able to, for example, view who is authorized to and/or who has seen, changed, or received updates regarding a Data Element 325. The party may be able to, for example, view what Workflows 340 have been completed, remain incomplete, or remain to be implemented. The party may be able to search for Kforms 315 and/or Data Elements 325 containing specific terms in a record name or a record value. For example, a party may be able to search for Data Elements 325 with a name containing “VIN” or with a value which follows the structure of a VIN number (which generally have a defined structure). If allowed by the Agreement Profile 320 settings for such record, the party may be able to “promote” the identified record as a Data Element 325 of a particular description, such as that the identified Data Element 325 is in the category or sub-category of “VIN Number” Data Elements 325. The Data Vault Routine 700 may therefore allow the party to step into portions of the other routines executed by the KM Server 200.

The above Detailed Description of embodiments is not intended to be exhaustive or to limit the disclosure to the precise form disclosed above. While specific embodiments of, and examples are described above for illustrative purposes, various equivalent modifications are possible within the scope of the system, as those skilled in the art will recognize. For example, while processes or blocks are presented in a given order, alternative embodiments may perform routines having operations, or employ systems having blocks, in a different order, and some processes or blocks may be deleted, moved, added, subdivided, combined, and/or modified. While processes or blocks are at times shown as being performed in series, these processes or blocks may instead be performed in parallel, or may be performed at different times. Further, any specific numbers noted herein are only examples; alternative implementations may employ differing values or ranges.

1. A method of mediating an agreement in a computer comprising a memory, the method comprising:
creating in the memory a set of customers and a set of Service Experts;
accessing in the memory an electronic document, which electronic document comprises at least one section comprising at least one data element, and at least one workflow comprising steps; and
performing the steps in the workflow.

2. The method of claim 1, wherein the electronic document is a record of information.

3. The method of claim 1, wherein the electronic document is a contract between a first customer and at least one other party.

4. The method of claim 3, wherein the one other party is a second customer.

5. The method of claim 3, wherein the one other party is a Service Expert.

6. The method of claim 1, further comprising creating the electronic document.

7. The method of claim 6, wherein creating the electronic document comprises receiving an unstructured source document, performing a semantic search on the unstructured source document, and determining the data element, section, and workflow comprising steps.

8. The method of claim 6, wherein creating the electronic document comprises receiving a template comprising the data element, section, and workflow comprising steps.

9. The method of claim 6, wherein creating the electronic document further comprises associating a portion of the electronic document with a description of such portion.

10. The method of claim 6, wherein creating the electronic document further comprises setting an access control for the section.

11. The method of claim 6, wherein creating the electronic document further comprises setting a principal party responsible to supply a value for the data element.

12. The method of claim 11, further comprising setting a party who will receive notice that the value for the data element has changed.

13. The method of claim 11, further comprising setting a party who will receive notice of the value for the data element.

14. The method of claim 11, further comprising receiving a delegation by the principal party responsible to supply a value for the data element, which delegation assigns a Service Expert to supply a value for the data element.

15. A computing apparatus for mediating an agreement, the apparatus comprising a processor and a memory storing instructions that, when executed by the processor, configure the apparatus to:
create in the memory a set of customers and a set of Service Experts;
access in the memory an electronic document, which electronic document comprises at least one section comprising at least one data element, and at least one workflow comprising steps; and
perform the steps in the workflow.

16. A non-transient computer-readable storage medium having stored thereon instructions that, when executed by a computing device comprising a processor and a memory, configure the processor to:
create in the memory a set of customers and a set of Service Experts;
access in the memory an electronic document, which electronic document comprises at least one section comprising at least one data element, and at least one workflow comprising steps; and
perform the steps in the workflow.
